(19) United States
(12) Patent Application Publication
(10) Pub. No.: US 2020/0313231 A1
(43) Pub. Date: Oct. 1, 2020

(54) CATHODE MIXTURE, ALL-SOLID-STATE BATTERY, AND METHOD OF PRODUCING CATHODE MIXTURE

(71) Applicant: TOYOTA JIDOSHA KABUSHIKI KAISHA, Toyota-shi (JP)

(72) Inventors: Kazuya TAKEUCHI, Susono-shi (JP); Masafumi NOSE, Susono-shi (JP)

(73) Assignee: TOYOTA JIDOSHA KABUSHIKI KAISHA, Toyota-shi (JP)

(21) Appl. No.: 16/819,803

(22) Filed: Mar. 16, 2020

(30) Foreign Application Priority Data
Mar. 25, 2019 (JP) 2019-057135

(51) Int. Cl. H01M 10/0562; H01M 10/052; H01M 10/39; H01M 4/58; H01M 4/36

(52) U.S. Cl. CPC H01M 10/0562; H01M 10/052; C01P 2002/74; H01M 4/5815; H01M 4/364; H01M 10/3954

(57) ABSTRACT

A cathode mixture having a low irreversible capacity is disclosed. The cathode mixture contains: a cathode active material having a S element; a sulfur-containing compound having a B element and a S element; and a conductive additive, wherein the cathode mixture does not substantially have a Li element, and a standard value that is defined by the following formula is at least 0.56 when the diffracted intensity at 11.5° in 2θ is defined as I_{11.5}, the diffracted intensity at 23.1° in 2θ is defined as I_{23.1}, and the diffracted intensity at 40° in 2θ is defined as I₄₀ in the X-ray diffraction measurement using CuKα radiation:

standard value=(I_{11.5}−I₄₀)/(I_{23.1}−I₄₀).

### FIELD

The present application discloses a cathode mixture, an all-solid-state battery, a method of producing a cathode mixture, etc.

### BACKGROUND

Sulfur (S) offers a very high theoretical capacity of 1675 mAh/g, and sulfur batteries using sulfur as a cathode active material are being developed. For example, N. Tanibata et al., “A novel discharge-charge mechanism of a S—P2S5 composite electrode without electrolytes in all-solid-state Li/S batteries”, J. Mater. Chem. A, 2017 5 11224-11228 discloses a cathode mixture containing a cathode active material having a S element, a sulfur-containing compound having a P element and a S element, and a conductive additive.

### SUMMARY

### Technical Problem

According to new findings of the inventors of the present disclosure, an irreversible capacity of a cathode mixture according to the foregoing conventional art is high. A battery constituted by using a cathode mixture of a high irreversible capacity leads to a low coulombic efficiency in the initial charge/discharge of the battery.

### Solution to Problem

As one means for solving the problem, the present application discloses a cathode mixture comprising: a cathode active material having a S element; a sulfur-containing compound having a B element and a S element; and a conductive additive, wherein the cathode mixture does not substantially have a Li element, and a standard value that is defined by the following formula is at least 0.56 when a diffracted intensity at 11.5° in 2θ is defined as I_{11.5}, a diffracted intensity at 23.1° in 2θ is defined as I_{23.1}, and a diffracted intensity at 40° in 2θ is defined as I₄₀ in X-ray diffraction measurement using CuKα radiation:

standard value=(I_{11.5}−I₄₀)/(I_{23.1}−I₄₀).

In the cathode mixture of the present disclosure, a molar ratio B/S of the B element to the S element may be 0.44 to 1.60.

In the cathode mixture of the present disclosure, the standard value may be at most 1.08.

In the cathode mixture of the present disclosure, the cathode mixture may substantially not have a P element.

In the cathode mixture of the present disclosure, the conductive additive may be a carbon material.

As one means for solving the problem, the present application discloses an all-solid-state battery comprising: a cathode mixture layer constituted of the cathode mixture of the present disclosure; an anode active material layer; and a solid electrolyte layer arranged between the cathode mixture layer and the anode active material layer.

As one means for solving the problem, the present application discloses a method of producing a cathode mixture, the method comprising: a preparing step of preparing a raw material containing a cathode active material having a S element, a sulfide having a B element and a S element, and a conductive additive, and not substantially having a Li element; and a mixing step of mixing the raw material to obtain the cathode mixture, wherein the cathode mixture contains the cathode active material having the S element, a sulfur-containing compound having the B element and the S element, and the conductive additive, and does not substantially have the Li element by adjusting mixing conditions for the raw material in the mixing step, a standard value of the cathode mixture being at least 0.56, the standard value being defined by the following formula when a diffracted intensity at 11.5° in 2θ is defined as I_{11.5}, a diffracted intensity at 23.1° in 2θ is defined as I_{23.1}, and a diffracted intensity at 40° in 2θ is defined as I₄₀ in X-ray diffraction measurement using CuKα radiation:

standard value=(I_{11.5}−I₄₀)/(I_{23.1}−I₄₀).

In the production method of the present disclosure, in the mixing step, the raw material may be mixed by mechanical milling.

### Advantageous Effects

The technique of the present disclosure makes it possible to obtain a cathode mixture of a low irreversible capacity, and an all-solid-state battery of a high coulombic efficiency in charge/discharge.

### BRIEF DESCRIPTION OF DRAWINGS

FIG. 1 is an explanatory schematic view of a cathode mixture 1;

FIG. 2 is an explanatory schematic view of an all-solid-state battery 100;

FIG. 3 is an explanatory flowchart of one example of a method of producing the cathode mixture 1;

FIG. 4 is a graph showing X-ray diffraction patterns of cathode mixtures of Examples and Comparative Examples;

FIG. 5 is a graph showing the relationship between the standard value of a cathode mixture using a sulfide having a B element and a S element, and the initial coulombic efficiency of the battery;

FIG. 6 is a graph showing transition of the discharge capacity retention from the first cycle to the fifth cycle in the overdischarge test;

FIG. 7 is a graph showing charge-discharge curves of the first to fifth cycles according to Reference Example in the overdischarge test;

FIG. 8 is a graph showing charge-discharge curves of the first to fifth cycles according to Example 2 in the overdischarge test; and

FIG. 9 is a graph showing charge-discharge curves of the first to fifth cycles according to Example 3 in the overdischarge test.

### DESCRIPTION OF EMBODIMENTS

### 1. Cathode Mixture

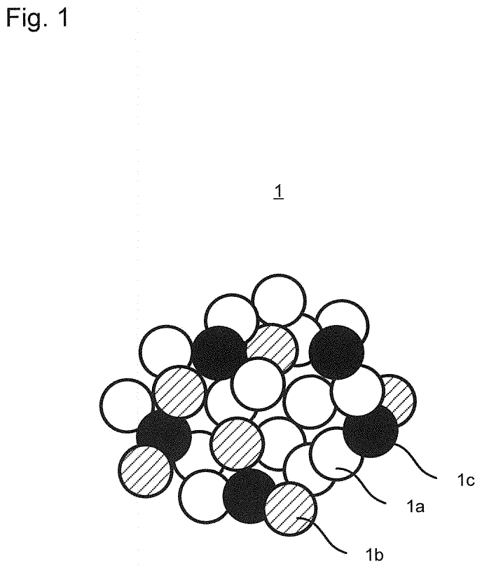

FIG. 1 schematically shows a cathode mixture 1. The cathode mixture 1 contains: a cathode active material having a S element 1a; a sulfur-containing compound having a B element and a S element 1b; and a conductive additive 1c. The cathode mixture 1 does not substantially have a Li element. Further, a standard value of the cathode mixture 1 which is defined by the following formula is at least 0.56 when the diffracted intensity at 11.5° in 2θ is defined as I_{11.5}, the diffracted intensity at 23.1° in 2θ is defined as I_{23.1}, and the diffracted intensity at 40° in 2θ is defined as I₄₀ in the X-ray diffraction measurement using CuKα radiation:

standard value=(I_{11.5}−I₄₀)/(I_{23.1}−I₄₀).

### 1.1. Cathode Active Material

The cathode mixture 1 contains the cathode active material having a S element 1a. Any material may be employed for the cathode active material having a S element 1a. For example, the cathode active material 1a may be elemental sulfur. Examples of elemental sulfur include octasulfur represented by S₈. S₈ can take any of three crystal shapes that are α-sulfur (orthorhombic sulfur), β-sulfur (monoclinic sulfur), and γ-sulfur (monoclinic sulfur), any of which may be employed here.

When the cathode mixture 1 contains elemental sulfur as the cathode active material 1a, a diffraction peak derived from crystalline elemental sulfur may either appear or not appear in the X-ray diffraction pattern of the cathode mixture 1. Typical peaks of elemental sulfur are at 23.05°±0.50°, 25.84°±0.50°, and 27.70°±0.50° in 2θ in the X-ray diffraction measurement using CuKα radiation. Each of these peak positions may be at 23.05°±0.30°, 25.84°±0.30°, and 27.70°±0.30° therein, and may be 23.05°±0.10°, 25.84°±0.10°, and 27.70°±0.10° therein.

The amount of the cathode active material 1a contained in the cathode mixture 1 is not particularly limited, and may be suitably determined according to the performance of the battery to be aimed. For example, the cathode mixture 1 may contain the cathode active material 1a of 10 mass % to 80 mass %. The lower limit thereof may be at least 15 mass %, may be at least 20 mass %, and may be at least 25 mass %. The upper limit thereof may be at most 70 mass %, and may be at most 60 mass %.

FIG. 1 shows the embodiment such that the cathode active material 1a, and a sulfur-containing compound etc. that will be described later exist in the cathode mixture 1 as different particles for a convenient description. The embodiment of the cathode mixture 1 is not limited to this. For example, part or all of the cathode active material 1a may form a solid solution along with a sulfur-containing compound described later in the cathode mixture 1. In other words, the cathode mixture 1 may contain a solid solution of the cathode active material 1a and a sulfur-containing compound. The S element in the cathode active material 1a, and a S element in a sulfur-containing compound may have a chemical bond (S—S bond).

### 1.2. Sulfur-Containing Compound

The cathode mixture 1 contains the sulfur-containing compound having a B element and a S element 1b. According to new findings of the inventors of the present disclosure, the cathode mixture 1 containing the sulfur-containing compound having a B element and a S element 1b improves the reduction resistance of the cathode mixture 1. The cathode mixture 1 may only contain the sulfur-containing compound 1b as a sulfur-containing compound, and may contain another sulfur-containing compound 1b′ that is not shown, together with the sulfur-containing compound 1b. The sulfur-containing compound 1b and the sulfur-containing compound 1b′ may be bonded to each other by a chemical bond.

A carrier ion reaching a cathode mixture layer in discharge of the battery reacts with the cathode active material 1a, which may generate a discharge product of a low ionic conductivity such as Li₂S and Na₂S. This may lead to a lack of ion conduction paths in the cathode mixture layer, which makes it difficult for the discharge reaction to progress. In contrast, when a sulfur-containing compound is present in a cathode mixture layer, it is believed that ion conduction paths are secured by the sulfur-containing compound in charge/discharge of the battery, which makes it easy for the discharge reaction to progress. According to new findings of the inventors of the present disclosure, the sulfur-containing compound having a B element and a S element 1b shows high reduction resistance in the cathode mixture, and thus can suppress deterioration of the cathode mixture due to a side reaction.

In the cathode mixture 1, a sulfur-containing compound may take any embodiment. For example, the cathode mixture 1 may contain a sulfur-containing compound having the structure of an ortho composition. That is, the sulfur-containing compound 1b may include the ortho structure of the B element. The ortho structure of the B element is, specifically, the BS₃ structure. The sulfur-containing compound 1b′ may include the ortho structure of an M element where M is, for example, Ge, Sn, Si or Al. Examples of the ortho structure of an M element include the GeS₄ structure, the SnS₄ structure, the SiS₄ structure, and the AlS₃ structure.

The cathode mixture 1 may contain a sulfide as a sulfur-containing compound. That is, the sulfur-containing compound 1b may have a sulfide of the B element (B₂S₃). The sulfur-containing compound 1b′ may have a sulfide of the M element (MₓS_{y}). Here, x and y are integers leading to electroneutrality toward S according to M. Examples of a sulfide of the M element (MₓS_{y}) include GeS₂, SnS₂, SiS₂, and Al₂S₃, which may be residues of raw materials described later.

A diffraction peak derived from a crystalline sulfide may either appear or not appear in the X-ray diffraction pattern of the cathode mixture 1. For example, typical peaks of GeS₂ are at 15.43°±0.50°, 26.50°±0.50°, and 28.60°±0.50° in 2θ in the X-ray diffraction measurement using CuKα radiation. Typical peaks of SnS₂ are at 15.02°±0.50°, 32.11°±0.50°, and 46.14°±0.50° in 2θ in the X-ray diffraction measurement using CuKα radiation. Typical peaks of SiS₂ are at 18.36°±0.50°, 29.36°±0.50°, and 47.31°±0.50° in 2θ in the X-ray diffraction measurement using CuKα radiation. For each of these peak positions, ±0.50° may be ±0.30°, and may be ±0.10°.

The amount of a sulfur-containing compound, that is, the total amount of the sulfur-containing compounds 1b and 1b′ contained in the cathode mixture 1 is not particularly limited, and may be suitably determined according to the performance of the battery to be aimed. For example, the cathode mixture 1 may contain a sulfur-containing compound of 10 mass % to 80 mass %. The lower limit thereof may be at least 15 mass %, may be at least 20 mass %, and may be at least 25 mass %. The upper limit thereof may be at most 70 mass %, and may be at most 60 mass %.

The main component of a sulfur-containing compound contained in the cathode mixture 1 may be the sulfur-containing compound having a B element and a S element 1b. Specifically, the sulfur-containing compound having a B element and a S element 1b of 50 mass % to 100 mass % may be contained when the total mass of a sulfur-containing compound contained in the cathode mixture 1 is defined as 100 mass %.

As described above, part or all of the cathode active material 1a may form a solid solution along with a sulfur-containing compound in the cathode mixture 1. The S element in the cathode active material 1a and a S element in a sulfur-containing compound may have a chemical bond (S—S bond).

When the cathode active material having a S element 1a, the sulfur-containing compound having a B element and a S element 1b, and the sulfur-containing compound having an M element and a S element 1b′ are bonded to one another in the cathode mixture 1 by a chemical bond, the mass ratio of the cathode active material 1a, the sulfur-containing compound 1b and the sulfur-containing compound 1b′ in the cathode mixture 1 shall be identified by conversion from the result of the element analysis etc. For example, one may identify the abundance (mol %) of each of the S element, the B element and the M element included in the cathode mixture 1 by the element analysis etc., convert the sulfur-containing compound 1b into a sulfide (B₂S₃) based on the abundance of the B element to identify the mass ratio thereof, convert the sulfur-containing compound 1b′ into a sulfide (MₓS_{y}) based on the abundance of the M element to identify the mass ratio thereof, and further convert excessive S that does not constitute the foregoing sulfides into elemental sulfur (S), which is the cathode active material 1a, to identify the mass ratio thereof.

### 1.3. Conductive Additive 1c

The conductive additive 1c has the function of improving the electronic conductivity of the cathode mixture 1. The conductive additive 1c is presumed to function as a reducing agent when, for example, a mixture is subjected to mechanical milling in a production method described later. The conductive additive 1c may be present as dispersing in the cathode mixture 1.

The cathode mixture 1 may contain a carbon material as the conductive additive 1c. Examples of the carbon material include vapor grown carbon fibers (VGCF), acetylene black, active carbon, furnace black, carbon nanotubes, ketjen black, and graphene. Or, the cathode mixture 1 may contain a metallic material as the conductive additive 1c. In the cathode mixture 1, two or more conductive additives may be used as the conductive additive 1c in combination.

The amount of the conductive additive 1c contained in the cathode mixture 1 is not particularly limited, and may be suitably determined according to the performance of the battery to be aimed. For example, the cathode mixture 1 may contain the conductive additive 1c of 5 mass % to 50 mass %. The lower limit thereof may be at least 10 mass %. The upper limit thereof may be at most 40 mass %.

### 1.4. Other Components

The cathode mixture 1 may either contain or not contain some additive component, in addition to the foregoing cathode active material, sulfur-containing compound and conductive additive as long as the foregoing problem may be solved. For example, the cathode mixture 1 may either contain or not contain a binder.

### 1.5. Supplement to Constituent Elements

### 1.5.1. B Element and S Element

The cathode mixture 1 essentially contains the B element and the S element since, as described above, essentially containing the cathode active material having a S element 1a, and the sulfur-containing compound having a B element and a S element 1b. Here, in the cathode mixture 1, the molar ratio B/S of the B element to the S element is not particularly limited. According to new findings of the inventors of the present disclosure, this molar ratio B/S of 0.44 to 1.60 may further lower the irreversible capacity of the cathode mixture 1. The molar ratio B/S may be at least 0.60, and may be at most 1.20.

### 1.5.2. Li Element

A cathode mixture containing an ionic conductor or a solid electrolyte, having a Li element is known as a conventional art. For example, an ionic conductor using Li₂S as a raw material is known. A capacity of a battery using such a cathode mixture however tends to lower since Li₂S has low water resistance. In contrast, the cathode mixture 1 does not substantially have a Li element, which can prevent the capacity from lowering as described above. “Not substantially have a Li element” means that the proportion of the Li element to all elements included in the cathode mixture 1 is at most 20 mol %. The proportion of the Li element may be at most 16 mol %, may be at most 8 mol %, may be at most 4 mol %, and may be 0 mol % or at most the detection limit.

### 1.5.3. Na Element

The cathode mixture 1 may substantially not have a Na element in the same view as for a Li element. “Not substantially have a Na element” means that the proportion of a Na element to all elements included in the cathode mixture is at most 20 mol %. The proportion of the Na element may be at most 16 mol %, may be at most 8 mol %, may be at most 4 mol %, and may be 0 mol % or at most the detection limit.

### 1.5.4. P Element

According to new findings of the inventors of the present disclosure, a cathode mixture having a P element may lead to deterioration thereof as P is reduced in charge/discharge of the battery. In this regard, the cathode mixture 1 may substantially not have a P element. “Not substantially have a P element” means that the proportion of a P element to all elements included in the cathode mixture 1 is at most 20 mol %. The proportion of the P element may be at most 16 mol %, may be at most 8 mol %, may be at most 4 mol %, and may be 0 mol % or at most the detection limit.

### 1.5.5. Other Elements

The cathode mixture 1 may either include or not include any additive element other than the foregoing elements, in addition to the foregoing elements as long as the foregoing problem may be solved. For example, the cathode mixture 1 may either include or not include an M element where M is, for example, Ge, Sn, Si or Al.

### 1.6. Standard Value

A standard value of the cathode mixture 1 which is defined by the following formula is at least 0.56 when the diffracted intensity at 11.5° in 2θ is defined as I_{11.5}, the diffracted intensity at 23.1° in 2θ is defined as I_{23.1}, and the diffracted intensity at 40° in 2θ is defined as I₄₀ in the X-ray diffraction measurement using CuKα radiation. This may lead to the cathode mixture 1 of a low irreversible capacity.

standard value=(I_{11.5}−I₄₀)/(I_{23.1}−I₄₀).

As described above, N. Tanibata et al. discloses a cathode mixture using a cathode active material having a S element, a sulfur-containing compound having a P element and a S element, and a conductive additive. However, according to new findings of the inventors of the present disclosure, an irreversible capacity of a cathode mixture synthesized by the method of N. Tanibata et al. is high. As a result of their intensive study on a cause thereof, the inventors of the present disclosure found that the irreversible capacity changes depending on amorphousness of a cathode mixture. That is, the irreversible capacity of the cathode mixture of N. Tanibata et al. tends to be high since the cathode mixture has low amorphousness. In contrast, the cathode mixture 1 of the present disclosure has high amorphousness. In other words, the cathode active material 1a, the sulfur-containing compound 1b (and 1b′) and the conductive additive 1c all highly disperse, which thus can lower the irreversible capacity.

Here, the amorphousness of the cathode mixture 1 of the present disclosure is identified by a predetermined standard value. The higher the amorphousness of the cathode mixture 1 is, the higher the diffracted intensity of a broad peak or a halo pattern within the range of 10° and 20° in 2θ is. The standard value defined by the following formula is used for expressing this point:

standard value=(I_{11.5}−I₄₀)/(I_{23.1}−I₄₀).

I_{11.5} is the diffracted intensity at 11.5° in 2θ, I_{23.1} is the diffracted intensity at 23.1° in 2θ, and I₄₀ is the diffracted intensity at 40° in 2θ. The foregoing diffracted intensity is obtained by the X-ray diffraction measurement using CuKα radiation. I_{11.5} is the diffracted intensity relating to a broad peak within the range of 10° and 20° in 2θ. In contrast, I_{23.1} is the diffracted intensity relating to a peak within the range of 20° and 30° in 2θ. I₄₀ is the diffracted intensity at a position where the amorphousness of the cathode mixture is difficult to have an influence, and is the standard specifying the relationship between Ins and I_{23.1}.

It is important that the standard value is at least 0.56 in the cathode mixture 1 of the present disclosure. The standard value of less than 0.56 tends to lead to a high irreversible capacity. The lower limit of the standard value may be at least 0.81, may be at least 0.82, and may be at least 0.86. The upper limit of the standard value is not particularly limited, and for example, may be at most 1.08.

### 1.7. Shape

The cathode mixture 1 may be in the form of powder, may be in the form of a mass of a plurality of agglomerating and attached particles, and may be in any form other than them. Any shape may be employed according to the embodiment etc. of the battery to be aimed.

### 2. All-Solid-State Battery

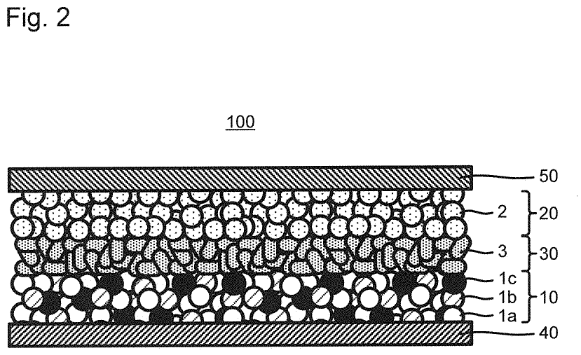

FIG. 2 shows one example of the structure of an all-solid-state battery 100. As shown in FIG. 2, the all-solid-state battery 100 includes a cathode mixture layer 10 constituted of the cathode mixture 1 of the present disclosure, an anode active material layer 20, and a solid electrolyte layer 30 arranged between the cathode mixture layer 10 and the anode active material layer 20.

### 2.1. Cathode Mixture Layer

The cathode mixture layer 10 is constituted of the foregoing cathode mixture 1, and thus, the irreversible capacity thereof is low. The cathode mixture layer 10 may have high reduction resistance since containing the sulfur-containing compound having a B element and a S element 1b. The thickness of the cathode mixture layer 10 is not particularly limited, and for example, may be 0.1 μm to 1000 μm. The coating amount of the cathode mixture layer 10 is not particularly limited, and for example, may be at least 3 mg/cm², may be at least 4 mg/cm², and may be at least 5 mg/cm². The cathode mixture layer 10 may be easily formed by, for example, pressing the cathode mixture 1.

### 2.2. Anode Active Material Layer

The anode active material layer 20 is a layer containing at least an anode active material 2. The anode active material 2 may have a Li element. Examples of such an anode active material include simple lithium or lithium alloys. Examples of lithium alloys include Li—In alloys. The anode active material 2 may have a Na element. Examples of such an anode active material 2 include simple sodium or sodium alloys. The anode active material layer 20 may contain at least one of a solid electrolyte, a conductive additive, and a binder as necessary. The conductive additive may be suitably selected from the foregoing conductive additives that may be contained in the cathode mixture 1. Examples of the binder include fluorine-based binders such as polyvinylidene fluoride (PVDF). The thickness of the anode active material layer 20 is not particularly limited, and for example, may be 0.1 μm to 1000 μm. The anode active material layer 20 may be easily formed by, for example, pressing the foregoing anode active material etc. Or, foil constituted of any of the foregoing materials may be employed for the anode active material layer 20.

### 2.3. Solid Electrolyte Layer

The solid electrolyte layer 30 is a layer formed between the cathode mixture layer 10 and the anode active material layer 20. The solid electrolyte layer 30 is a layer containing at least a solid electrolyte 3, and may contain a binder as necessary. Examples of the solid electrolyte include sulfide solid electrolytes, oxide solid electrolytes, nitride solid electrolytes, and halide solid electrolytes. Among them, a sulfide solid electrolyte is preferable. The sulfide solid electrolyte preferably has a Li element, an A element where A is at least one of P, Ge, Si, Sn, B and Al, and a S element. The sulfide solid electrolyte may further have a halogen element. Examples of a halogen element include a F element, a Cl element, a Br element, and an I element. The sulfide solid electrolyte may further have an O element. Examples of the sulfide solid electrolyte include Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ where m and n are positive numbers, and Z is any of Ge, Zn and Ga, Li₂S—GeS₂, Li₂S—SiS₂—Li₃PO₄, and Li₂S—SiS₂—LiₓMO_{y} where x and y are positive numbers, and M is any of P, Si, Ge, B, Al, Ga and In. The proportion of the solid electrolyte contained in the solid electrolyte layer 30 is not particularly limited, and for example, may be at least 50 volume %, may be at least 70 volume %, and may be at least 90 volume %. The binder used in the solid electrolyte layer 30 is the same as in the description about the anode active material layer 20. The thickness of the solid electrolyte layer 30 is not particularly limited, and for example, may be 0.1 μm to 1000 μm. The solid electrolyte layer 30 may be easily formed by, for example, pressing the foregoing solid electrolyte etc.

### 2.4. Other Components

As shown in FIG. 2, the all-solid-state battery 100 may include a cathode current collector 40 collecting a current of the cathode mixture layer 10, and an anode current collector 50 collecting a current of the anode active material layer 20. For example, each current collector may be in the form of foil, and may be in the form of mesh. Examples of a material of the cathode current collector 40 include SUS, aluminum, nickel, iron, titanium, and carbon. In contrast, examples of a material of the anode current collector 50 include SUS, copper, nickel, and carbon. Further, the all-solid-state battery 100 may include other members such as a battery case and a terminal.

The all-solid-state battery 100 may be a sulfur battery. A sulfur battery is a battery using elemental sulfur as the cathode active material 1a. The all-solid-state battery 100 may be a lithium-sulfur battery or LiS battery, and may be sodium-sulfur battery or NaS battery. The all-solid-state battery may be a primary battery, and may be a secondary battery. A secondary battery is preferable because repeatedly chargeable and dischargeable, and useful as, for example, an onboard battery. A secondary battery encompasses a secondary battery used like a primary battery, that is, used for the purpose of only one discharge after charge.

### 3. Method of Producing Cathode Mixture

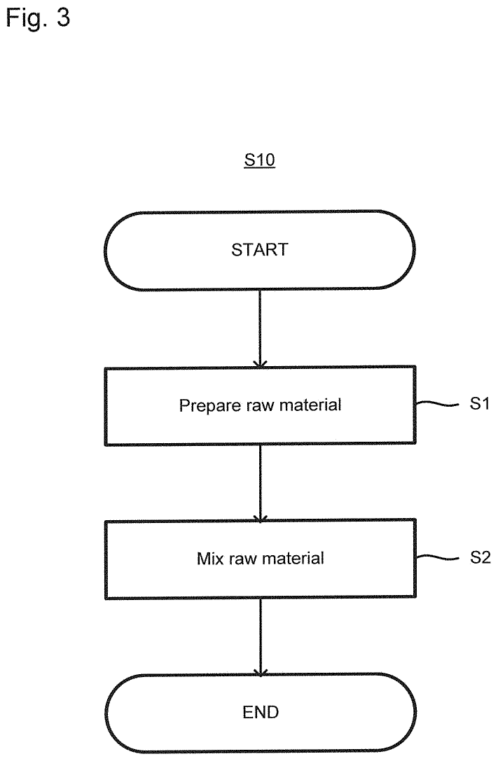

FIG. 3 shows one example of a method of producing the cathode mixture. A method of producing the cathode mixture S10 shown in FIG. 3 includes a preparing step S1 of preparing a raw material containing a cathode active material having a S element, a sulfide having a B element and a S element, and a conductive additive, and not substantially having a Li element; and a mixing step S2 of mixing the raw material to obtain the cathode mixture. Here, in the production method S10, the cathode mixture 1 containing the cathode active material having the S element 1a, the sulfur-containing compound having the B element and the S element 1b, and the conductive additive 1c, and not substantially having the Li element is obtained by adjusting the mixing conditions for the raw material in the mixing step S2, a standard value of the cathode mixture being at least 0.56, the standard value being defined by the following formula when the diffracted intensity at 11.5° in 2θ is defined as I_{11.5}, the diffracted intensity at 23.1° in 2θ is defined as I_{23.1}, and the diffracted intensity at 40° in 2θ is defined as I₄₀ in the X-ray diffraction measurement using CuKα radiation:

standard value=(I_{11.5}−I₄₀)/(I_{23.1}−I₄₀).

### 3.1. Preparation of Raw Material

The preparation step S1 is a step of preparing a raw material containing a cathode active material having a S element, a sulfide having a B element and a S element, and a conductive additive, and not substantially having a Li element. The raw material may be made by oneself, and may be purchased from a supplier.

The raw material may only contain the cathode active material, the sulfide and the conductive additive, and may further contain any other materials. The raw material does not substantially have a Li element as described above. The raw material may not substantially have a Na element, and may not substantially have a P element.

The cathode active material may be elemental sulfur as described above. Elemental sulfur of high purity is preferable. In contrast, examples of the sulfide having a B element and a S element include B₂S₃. The raw material may only contain a sulfide of a B element, may further contain a sulfide of an M element, and may contain a composite sulfide of a B element and an M element, as the sulfide. Examples of a sulfide of an M element include GeS₂, SnS₂, SiS₂ and Al₂S₃. The raw material may contain only one sulfide of an M element, and may contain two or more sulfides of an M element. The conductive additive is as described above, and description thereof is omitted here.

The content of the cathode active material in the raw material may be, for example, at least 10 mass %, may be at least 20 mass %, and may be at least 25 mass %. Too low a content of the cathode active material may make it impossible to obtain the cathode mixture of a sufficient capacity. In contrast, the content of the cathode active material in the raw material may be, for example, at most 80 mass %, may be at most 70 mass %, and may be at most 60 mass %. Too high a content of the cathode active material may lead to a lack of the ionic conductivity and the electronic conductivity of the cathode mixture.

The content of the sulfide, especially the sulfide having a B element and a S element in the raw material may be, for example, at least 10 mass %, and may be at least 20 mass %. Too low a content of the sulfide may lead to a lack of the ionic conductivity of the cathode mixture. In contrast, the content of the sulfide in the raw material may be, for example, at most 80 mass %, and may be at most 70 mass %. Too high a content of the sulfide relatively lowers the content of the cathode active material, which may make it impossible to obtain the cathode mixture of a sufficient capacity.

The content of the conductive additive in the raw material may be, for example, at least 5 mass %, and may be at least 10 mass %. Too low a content of the conductive additive may lead to a lack of the electronic conductivity of the cathode mixture. In contrast, the content of the conductive additive in the raw material may be, for example, at most 50 mass %, and may be at most 40 mass %. Too high a content of the conductive additive relatively lowers the content of the cathode active material, which may make it impossible to obtain the cathode mixture of a sufficient capacity.

In the raw material, the mass ratio of the sulfide, especially the sulfide having a B element and a S element to the cathode active material is not particularly limited. For example, the mixing ratio of the cathode active material and the sulfide may be adjusted so that the molar ratio B/S of the B element to the S element in the raw material is 0.44 to 1.60.

### 3.2. Mixing of Raw Material

The mixing step S2 is a step of mixing the raw material to obtain the cathode mixture. A means for mixing the raw material is not particularly limited. For example, the raw material may be mixed by mechanical milling. The raw material may be easily amorphized by mechanical milling.

Any mechanical milling may be used as long as being the method of mixing the raw material as applying mechanical energy. Examples thereof include ball milling, vibrating milling, turbo milling, the mechanofusion, and disk milling. Planetary ball milling may be employed in view of further easily amorphizing the raw material.

Mechanical milling may be dry mechanical milling, and may be wet mechanical milling. Examples of a liquid used in wet mechanical milling include aprotic liquids such that hydrogen sulfide is not generated. Specific examples thereof include aprotic liquids such as polar aprotic liquids and nonpolar aprotic liquids.

In the mixing step S2, the cathode mixture containing the cathode active material having a S element 1a, the sulfur-containing compound having a B element and a S element 1b, and the conductive additive 1c, and not substantially having a Li element is obtained by adjusting the mixing conditions for the raw material, a standard value of the cathode mixture 1 being at least 0.56, the standard value being defined by the foregoing formula when the diffracted intensity at 11.5° in 2θ is defined as I_{11.5}, the diffracted intensity at 23.1° in 2θ is defined as I_{23.1}, and the diffracted intensity at 40° in 2θ is defined as I₄₀ in the X-ray diffraction measurement using CuKα radiation. For example, when planetary ball milling is used in the mixing step S2, the raw material and grinding balls are added into a jar, and the process is carried out at a predetermined disk rotation speed for a predetermined time. The disk rotation speed may be at least 200 rpm, may be at least 300 rpm, and may be at least 510 rpm. In contrast, the disk rotation speed may be at most 800 rpm, and may be at most 600 rpm. The processing time for planetary ball milling may be at least 30 minutes, and may be at least 5 hours. In contrast, the processing time for planetary ball milling may be at most 100 hours, and may be at most 60 hours. Examples of materials of a jar and grinding balls used for planetary ball milling include ZrO₂ and Al₂O₃. The diameter of each grinding ball may be, for example, 1 mm to 20 mm. Mechanical milling may be carried out in an inert gas atmosphere such as an Ar gas atmosphere.

### 4. Supplement

The foregoing embodiment is one example of the technique of the present disclosure, and does not limit the technique of the present disclosure.

### EXAMPLES

The technique of the present disclosure will be hereinafter described further with reference to Examples, but is not limited to the following modes.

### 1. Evaluation of Irreversible Capacity

### 1.1. Example 1

### 1.1.1. Making Cathode Mixture

Elemental sulfur of a cathode active material manufactured by Kojundo Chemical Laboratory Co., Ltd., B₂S₃ of a sulfide, and VGCF of a conductive additive were prepared. They were weighed so that the mass ratio thereof was as in the following Table 1, and kneaded by means of a mortar for 15 minutes, to obtain a raw material. The obtained raw material was put into a jar of 45 cc for planetary ball milling made from ZrO₂, 96 g of ZrO₂ balls of 4 mm in diameter was further put thereinto, and then the jar was completely sealed. This jar was attached to a planetary ball mill machine of P7 manufactured by Fritsch, to be subjected to mechanical milling for 48 hours in total, in which the cycle of 1-hour mechanical milling at 500 rpm in disk rotation speed, a 15-minute rest, 1-hour mechanical milling reversely at 500 rpm in disk rotation speed, and a 15-minute rest was repeated. Thereby a cathode mixture was obtained.

### 1.1.2. Making all-Solid-State Battery

Into a ceramic mold of 1 cm², 100 mg of a solid electrolyte was put to be pressed at 1 ton/cm², to obtain a solid electrolyte layer. On the one side thereof, 7.8 mg, that is, 7.8 mg/cm² in coating amount of the cathode mixture was put to be pressed at 6 ton/cm², to form a cathode mixture layer. On the other side thereof, lithium metal foil that was an anode active material layer was arranged to be pressed at 1 ton/cm², to obtain an electric element. Al foil of a cathode current collector was arranged on the cathode mixture layer side, and Cu foil of an anode current collector was arranged on the anode active material layer side. Thereby, an all-solid-state battery was obtained.

### 1.2. Examples 2 to 7 and Comparative Examples 1 to 3

A cathode mixture and an all-solid-state battery were made in the same manner as in Example 1 except that each material was weighed so that their mass ratio was as in the following Table 1, and the conditions for mechanical milling were suitably adjusted. In Comparative Example 1, P₂S₅ was used instead of B₂S₃.

TABLE 1

| | | | | | Mass | Mass | Molar | Molar |
|---|---|---|---|---|---|---|---|---|
| | | B₂S3 | P₂S₅ | | ratio | ratio | ratio | ratio |
| | S (g) | (g) | (g) | C (g) | B₂S₃/S | P₂S₅/S | B/S | P/S |
| Comp. | 1.050 | — | 0.385 | 0.570 | — | 0.37 | — | 0.08 |
| Ex. 1 | | | | | | | | |
| Comp. | 1.050 | 0.193 | — | 0.570 | 0.18 | — | 0.10 | — |
| Ex. 2 | | | | | | | | |
| Comp. | 1.050 | 0.386 | — | 0.570 | 0.37 | — | 0.20 | — |
| Ex. 3 | | | | | | | | |
| Example 1 | 1.050 | 0.852 | — | 0.570 | 0.81 | — | 0.44 | — |
| Example 2 | 1.050 | 1.157 | — | 0.570 | 1.10 | — | 0.60 | — |
| Example 3 | 1.050 | 1.543 | — | 0.570 | 1.47 | — | 0.80 | — |
| Example 4 | 1.050 | 1.928 | — | 0.570 | 1.84 | — | 1.00 | — |
| Example 5 | 1.050 | 2.314 | — | 0.570 | 2.20 | — | 1.20 | — |
| Example 6 | 1.050 | 2.700 | — | 0.570 | 2.57 | — | 1.40 | — |
| Example 7 | 1.050 | 3.986 | — | 0.570 | 3.80 | — | 1.60 | — |

### 1.3. Evaluation Method

### 1.3.1. X-Ray Diffraction

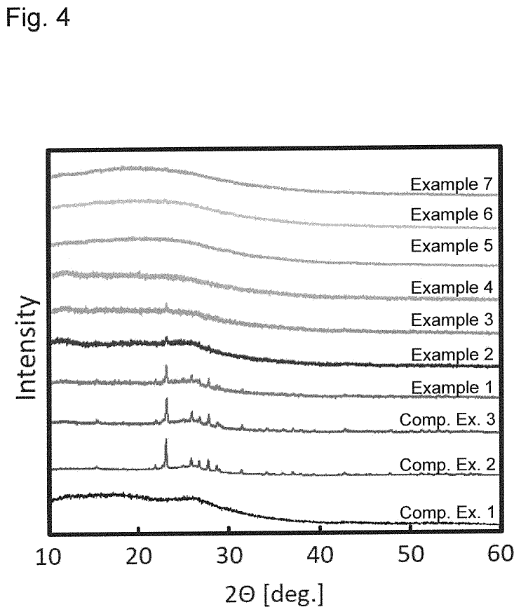

The cathode mixture of each of Examples 1 to 7 and Comparative Examples 1 to 3 was subjected to the X-ray diffraction (XRD) measurement using CuKα radiation. The results are shown in FIG. 4. The following are found out from the results shown in FIG. 4, and the results in (a) of FIG. 1 of Tanibata et al.: that is, in Examples 1 to 7, a broad peak or a halo pattern is confirmed within the range of 10° and 20° in 2θ, and the peaks derived from the residues of the raw material within the range of 20° and 30° in 2θ are low. In contrast, in Comparative Examples 1 to 3, and (a) of FIG. 1 of Tanibata et al., a broad peak within the range of 10° and 20° in 2θ is not confirmed, and is just a slight peak even if confirmed. Further, in Comparative Examples 2 to 3, the peaks derived from the residues of the raw material within the range of 20° and 30° in 2θ are high.

From the obtained results of the X-ray diffraction measurement, the standard value was calculated: the standard value was defined by the following formula where the diffracted intensity at 11.5° in 2θ was defined as I_{11.5}, the diffracted intensity at 23.1° in 2θ was defined as I_{23.1}, and the diffracted intensity at 40° in 2θ was defined as I₄₀. This standard value is an index of amorphousness. A larger standard value means higher amorphousness. The standard value calculated for each of Examples 1 to 7 and Comparative Examples 1 to 3 are shown in the following Table 2.

standard value=(I_{11.5}−I₄₀)/(I_{23.1}−I₄₀)

### 1.3.2. Measurement of Irreversible Capacity and Coulombic Efficiency

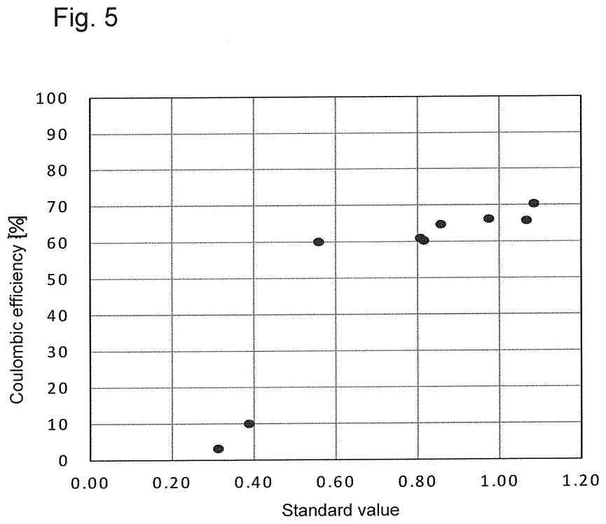

The charge/discharge test was carried out on each of the all-solid-state batteries of Examples 1 to 7 and Comparative Examples 1 to 3. The charge/discharge test was carried out by the following steps. First, the open-circuit voltage (OCV) of the all-solid-state battery after at least 1 minute has passed since the battery was made was measured. Next, the battery was discharged to 1.5 V (vs Li/Li⁺) under the environment of 60° C. at C/10 (456 μA/cm²), and after a 10-minute rest, charged to 3.1 V at C/10. Thereby the initial discharge capacity and the initial charge capacity were measured. The difference between the initial discharge capacity and the initial charge capacity was obtained as an irreversible capacity, and the proportion of the initial charge capacity to the initial discharge capacity was obtained as coulombic efficiency. The results are shown in the following Table 2 and FIG. 5.

TABLE 2

| | Charge/ | | | Initial | Initial | | |
|---|---|---|---|---|---|---|---|
| | discharge | Coating | | discharge | charge | Irreversible | Coulombic |
| | current | (amount | Standard | capacity | capacity | capacity | efficiency |
| | (μAh/cm²) | (mg/cm²) | value | (mAh/cm²) | (mAh/cm²) | (mAh/cm²) | (%) |
| Comp. Ex. 1 | 456 | 7.8 | 1.11 | 6.00 | 1.47 | 4.53 | 24.5 |
| Comp. Ex. 2 | 456 | 7.8 | 0.31 | 1.86 | 0.06 | 1.80 | 3.1 |
| Comp. Ex. 3 | 456 | 7.8 | 0.39 | 3.64 | 0.36 | 3.28 | 9.9 |
| Example 1 | 456 | 7.8 | 0.56 | 3.95 | 2.37 | 1.58 | 60.0 |
| Example 2 | 456 | 7.8 | 1.08 | 4.97 | 3.49 | 1.48 | 70.2 |
| Example 3 | 456 | 7.8 | 0.97 | 4.29 | 2.84 | 1.46 | 66.1 |
| Example 4 | 456 | 7.8 | 1.07 | 4.10 | 2.69 | 1.41 | 65.7 |
| Example 5 | 456 | 7.8 | 0.86 | 3.07 | 1.99 | 1.09 | 64.7 |
| Example 6 | 456 | 7.8 | 0.81 | 3.15 | 1.92 | 1.23 | 60.9 |
| Example 7 | 456 | 7.8 | 0.82 | 2.47 | 1.49 | 0.98 | 60.2 |

As shown in Table 2 and FIG. 5, the cathode mixture having a B element and whose standard value is at least 0.56 (Examples 1 to 7) has a lower irreversible capacity, and higher coulombic efficiency of at least 60% in the initial charge/discharge as a secondary battery, than the cathode mixture not having a B element (Comparative Example 1), and the cathode mixture whose standard value is smaller than 0.56 (Comparative Examples 2 to 3).

### 2. Evaluation of Overdischarge Protection

According to findings of the inventors of the present disclosure, improving amorphousness of a cathode mixture may lower the irreversible capacity as well when P₂S₅ is used in the cathode mixture as a sulfide (see Japanese Unpublished Patent Application No. 2018-106324, the applicant of which is the same as that of the present application). According to new findings of the inventors of the present disclosure, using P₂S₅ as a sulfide may however cause a side reaction due to reduction of P at 1.5 V or lower in voltage of the battery to deteriorate a cathode, which may lower the discharge capacity of the battery as the charge/discharge cycle is repeated. In contrast, when B₂S₃ is used as a sulfide, B shows high reduction resistance in a cathode mixture, which makes it difficult to lower the discharge capacity of the battery as the charge/discharge cycle is repeated. The foregoing advantage of B over P will be described hereinafter with reference to Examples.

### 2.1. Reference Example

A cathode mixture and an all-solid-state battery were made in the same manner as in Example 1 except that each material was weighed so that their mass ratio was as in the following Table 3, and the conditions for mechanical milling were suitably adjusted.

TABLE 3

| | | | | | Mass | Mass | Molar | Molar |
|---|---|---|---|---|---|---|---|---|
| | | B₂S3 | P₂S₅ | | ratio | ratio | ratio | ratio |
| | S (g) | (g) | (g) | C (g) | B₂S₃/S | P₂S₅/S | B/S | P/S |
| Ref. Ex. | 1.050 | — | 0.852 | 0.570 | — | 0.81 | — | 0.15 |

### 2.2. Examples

A cathode mixture and an all-solid-state battery were made in the same manner as in each of Examples 2 and 3.

### 2.3. Evaluation Conditions

### 2.3.1. Standard Value and Coulombic Efficiency

A standard value of the all-solid-state battery of Reference Example was measured by means of X-ray diffraction in the same manner as described above. The charge/discharge test was carried out in the same manner as described above, and the coulombic efficiency in the initial charge/discharge was measured. The results are shown in the following Table 4.

### 2.3.2. Discharge Capacity Retention in Overdischarge Test

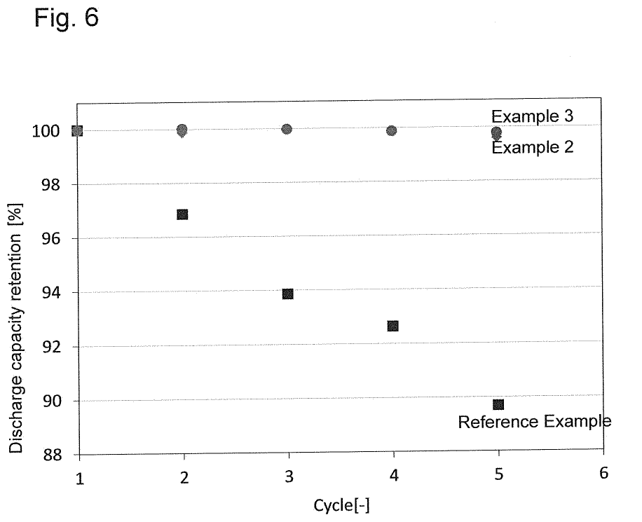

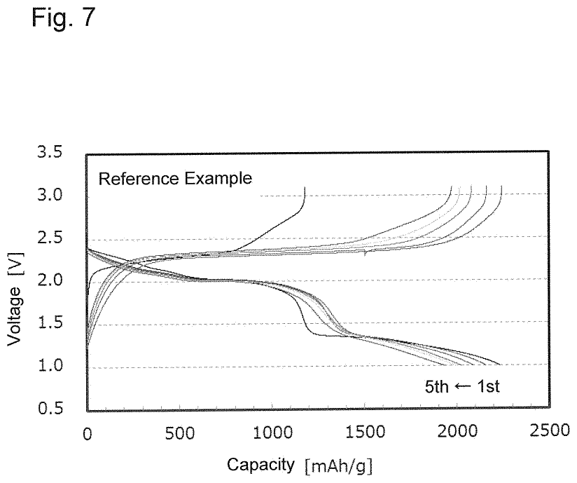

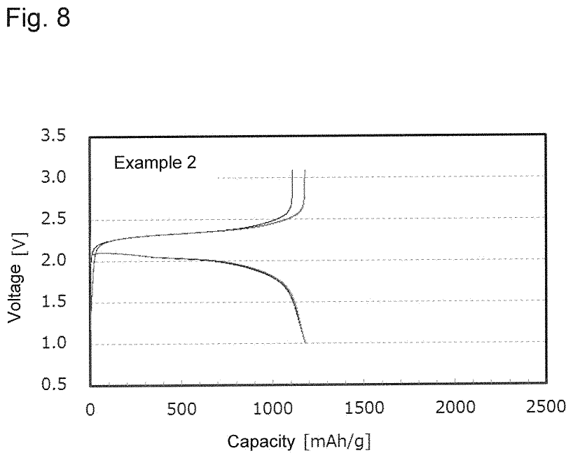

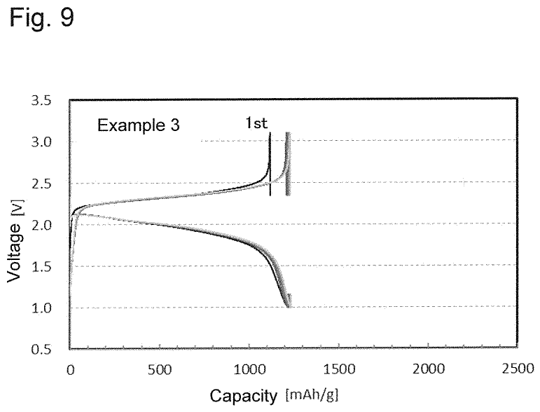

The charge/discharge cycle of discharge to 1 V (vs Li/Li+) under the environment of 60° C. at C/10 (456 μA/cm²), a 10-minute rest, and charge to 3.1 V at C/10 was repeatedly carried out on the made battery, and the discharge capacity retentions after the second cycle were confirmed when the discharge capacity at the first cycle was defined as 100%. The discharge capacity retention of the fifth cycle to the first cycle is shown in the following Table 4. FIG. 6 shows transition of the discharge capacity retention from the first cycle to the fifth cycle. Further, FIG. 7 shows the charge-discharge curves of the first to fifth cycles according to Reference Example, FIG. 8 shows the charge-discharge curves of the first to fifth cycles according to Example 2, and FIG. 9 shows the charge-discharge curves of the first to fifth cycles according to Example 3.

TABLE 4

| | Standard | Coulombic | Discharge capacity |
|---|---|---|---|
| | value | efficiency (%) | retention (%) |
| Ref. Ex. | 1.30 | 64.7 | 89.7 |
| Example 2 | 1.08 | 70.2 | 99.6 |
| Example 3 | 0.97 | 66.1 | 99.8 |

As shown in Table 4 and FIGS. 6 to 9, in Reference Example of using P₂S₅ as the raw material of the cathode mixture, the discharge capacity gradually lowers as the charge/discharge cycle is repeated. In contrast, in both Examples 2 and 3 of using B₂S₃ as the raw material of the cathode mixture, the discharge capacity hardly lowers even as the charge/discharge cycle is repeated. Like this, a cathode mixture containing a sulfur-containing compound having a B element and a S element shows high overdischarge protection, compared to a cathode mixture containing a sulfur-containing compound having a P element and a S element.

### 3. Supplement

The foregoing Examples show the case where elemental sulfur was used as the cathode active material, only B₂S₃ was used as the sulfide, and VGCF, which is a carbon material, was used as the conductive additive. The technique of the present disclosure is not limitedly applied to this mode. It is believed that any cathode active material having a S element may offer the same effect, any sulfide having a B element and a S element may offer the same effect, and any conductive additive having conductivity, such as various carbon materials and even metallic materials may offer the same effect. Needless to say, any sulfide other than B₂S₃, other additives, etc. may be contained as long as a desired effect may be obtained.

### INDUSTRIAL APPLICABILITY

The all-solid-state battery using the cathode mixture of the present disclosure may be used as a power source in a wide range such as an onboard large-sized power source and a small-sized power source for portable terminals.

### REFERENCE SIGN LIST

1 cathode mixture
1a cathode active material
1b sulfur-containing compound
1c conductive additive
2 anode active material
3 solid electrolyte
10 cathode mixture layer
20 anode active material layer
30 solid electrolyte layer
40 cathode current collector
50 anode current collector
100 all-solid-state battery

What is claimed is:

1. A cathode mixture comprising:
a cathode active material having a S element;
a sulfur-containing compound having a B element and a S element; and
a conductive additive,
wherein the cathode mixture does not substantially have a Li element, and
a standard value that is defined by the following formula is at least 0.56 when a diffracted intensity at 11.5° in 2θ is defined as I_{11.5}, a diffracted intensity at 23.1° in 2θ is defined as I_{23.1}, and a diffracted intensity at 40° in 2θ is defined as I₄₀ in X-ray diffraction measurement using CuKα radiation:
standard value=(I_{11.5}−I₄₀)/(I_{23.1}−I₄₀).

2. The cathode mixture according to claim 1, wherein a molar ratio B/S of the B element to the S element is 0.44 to 1.60.

3. The cathode mixture according to claim 1, wherein the standard value is at most 1.08.

4. The cathode mixture according to claim 1, wherein the cathode mixture does not substantially have a P element.

5. The cathode mixture according to claim 1, wherein the conductive additive is a carbon material.

6. An all-solid-state battery comprising:
a cathode mixture layer constituted of the cathode mixture according to claim 1;
an anode active material layer; and
a solid electrolyte layer arranged between the cathode mixture layer and the anode active material layer.

7. A method of producing a cathode mixture, the method comprising:
a preparing step of preparing a raw material containing a cathode active material having a S element, a sulfide having a B element and a S element, and a conductive additive, and not substantially having a Li element; and
a mixing step of mixing the raw material to obtain the cathode mixture,
wherein the cathode mixture containing the cathode active material having the S element, a sulfur-containing compound having the B element and the S element, and the conductive additive, and not substantially having the Li element is obtained by adjusting mixing conditions for the raw material in the mixing step, a standard value of the cathode mixture being at least 0.56, the standard value being defined by the following formula when a diffracted intensity at 11.5° in 2θ is defined as I_{11.5}, a diffracted intensity at 23.1° in 2θ is defined as I_{23.1}, and a diffracted intensity at 40° in 2θ is defined as I₄₀ in X-ray diffraction measurement using CuKα radiation:
standard value=(I_{11.5}−I₄₀)/(I_{23.1}−I₄₀).

8. The method according to claim 7, wherein in the mixing step, the raw material is mixed by mechanical milling.
